(19) United States
(12) Patent Application Publication
(10) Pub. No.: US 2025/0321443 A1
(43) Pub. Date: Oct. 16, 2025

(54) DISPLAY DEVICE

(71) Applicant: Japan Display Inc., Tokyo (JP)

(72) Inventor: Hirofumi OHIRA, Tokyo (JP)

(73) Assignee: Japan Display Inc., Tokyo (JP)

(21) Appl. No.: 19/172,674

(22) Filed: Apr. 8, 2025

(30) Foreign Application Priority Data
Apr. 12, 2024 (JP) 2024-064402

(51) Int. Cl. G02F 1/13; G02F 1/1335; G02F 1/13363; G02F 1/139

(52) U.S. Cl. CPC G02F 1/1323; G02F 1/133528; G02F 1/133638; G02F 1/1393; G02F 1/1396

(57) ABSTRACT

According to an aspect, a display device includes: a liquid crystal display panel including a display region configured to output an image; a light source configured to emit light to one surface side of the liquid crystal display panel; and a light adjuster interposed between the liquid crystal display panel and the light source and configured to control the transmission degree of light between the liquid crystal display panel and the light source. The light adjuster includes a first liquid crystal panel and a second liquid crystal panel that are stacked in a direction in which the light source and the liquid crystal display panel face each other. The first liquid crystal panel is a TN-mode liquid crystal panel, and the second liquid crystal panel is an ECB-mode liquid crystal panel.

### CROSS-REFERENCE TO RELATED APPLICATION

This application claims the benefit of priority from Japanese Patent Application No. 2024-064402 filed on Apr. 12, 2024, the entire contents of which are incorporated herein by reference.

### BACKGROUND

### 1. Technical Field

What is disclosed herein relates to a display device.

### 2. Description of the Related Art

In recent years, there has been a demand for a display device capable of changing the range of viewing angles at which an image can be viewed. For example, a display device mounted on a vehicle such as a four-wheel automobile is desired to achieve a range of viewing angle at which an image can be viewed from the front passenger seat side and the image cannot be viewed from the driver seat side only during driving. To achieve such a viewing angle range, technologies of placing a liquid crystal panel for light adjustment with a switchable viewing angle range over an image display panel have been disclosed, as described in Japanese Patent Application Laid-open Publication No. 2006-195388 (JP-A-2006-195388).

In the configuration disclosed in JP-A-2006-195388, the viewing angle range is controlled by reducing as much as possible light emission toward one side (driver seat side) of the front of the display device while allowing light emission toward the other side thereof. However, with the configuration disclosed in JP-A-2006-195388, light toward the other side in a range where the oblique angle with respect to the front is so large that it does not contribute to visual recognition of an image from the other side (front passenger seat side), is reflected toward the one side by a light-reflecting component such as a side window glass of a four-wheel automobile. As a result, the image can also be viewed from the one side. To reduce such image visual recognition from the one side, leakage of light from the other side, which does not contribute to image visual recognition, needs to be reduced.

For the foregoing reasons, there is a need for a display device capable of further reducing light leakage.

### SUMMARY

According to an aspect, a display device includes: a liquid crystal display panel including a display region configured to output an image; a light source configured to emit light to one surface side of the liquid crystal display panel; and a light adjuster interposed between the liquid crystal display panel and the light source and configured to control the transmission degree of light between the liquid crystal display panel and the light source. The light adjuster includes a first liquid crystal panel and a second liquid crystal panel that are stacked in a direction in which the light source and the liquid crystal display panel face each other. The first liquid crystal panel is a TN-mode liquid crystal panel, and the second liquid crystal panel is an ECB-mode liquid crystal panel.

### BRIEF DESCRIPTION OF THE DRAWINGS

FIG. 1 is a schematic view illustrating an example of a main configuration of a display device according to an embodiment;

FIG. 2 is a schematic sectional view of components included in the display device;

FIG. 3 is a diagram illustrating optical effects provided to light emitted by a light source until the light reaches a display panel;

FIG. 4 is a diagram illustrating an exemplary viewing angle characteristic of the display device that is obtained in accordance with the transmission degree of light when a first liquid crystal panel is in operation (ON);

FIG. 5 is a schematic diagram illustrating an example of the relation between the display device, a user U1 who can view the image DSP regardless of whether a liquid crystal panel is in operation or non-operation (ON or OFF), and a user U2 who cannot view the image DSP when the liquid crystal panel is in operation (ON);

FIG. 6 is a schematic view illustrating a difference between the image DSP viewed by a user viewing the display device from the front and the image DSP viewed by a user obliquely viewing the display device;

FIG. 7 is a multiple line graph illustrating the relation between a first direction polar angle and the light transmittance of the first liquid crystal panel in operation;

FIG. 8 is a multiple line graph illustrating the relation between the first direction polar angle and the light transmittance of a second liquid crystal panel in operation;

FIG. 9 is a multiple line graph illustrating a brightness difference between the display device of the embodiment and a comparative example in which only a TN-mode liquid crystal panel is provided in a light adjuster;

FIG. 10 is a schematic view illustrating the difference between an E mode and an O mode;

FIG. 11 is a diagram illustrating optical effects when the second liquid crystal panel is disposed closer to the light source relative to the first liquid crystal panel, and the stacking order of components that cause such effects; and

FIG. 12 is a diagram illustrating optical effects of the light adjuster due to stacking structures different from the configurations described above with reference to FIGS. 3 and 11, and the stacking order of components that cause such effects.

### DETAILED DESCRIPTION

An embodiment of the present disclosure is described below with reference to the drawings. What is disclosed herein is only an example, and any modification that can be easily conceived by those skilled in the art while maintaining the main purpose of the invention are naturally included in the scope of the present disclosure. The drawings may be schematically represented in terms of the width, thickness, shape, etc. of each part compared to those in the actual form for the purpose of clearer explanation, but they are only examples and do not limit the interpretation of the present disclosure. In the present specification and the drawings, the same reference sign is applied to the same elements as those already described for the previously mentioned drawings, and detailed explanations may be omitted as appropriate.

### Embodiment

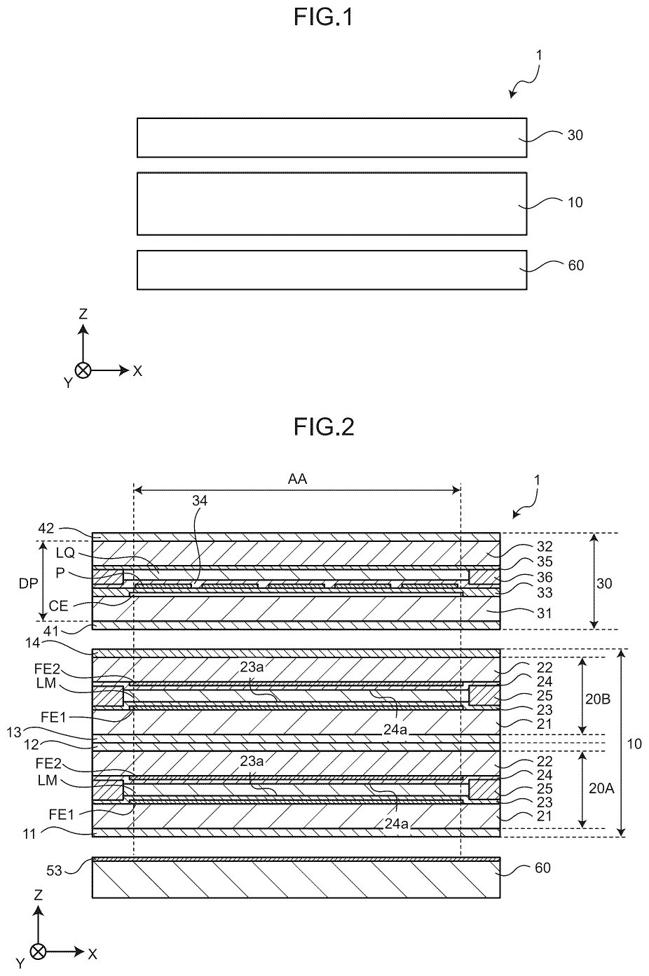

FIG. 1 is a schematic view illustrating an example of a main configuration of a display device 1 according to an embodiment. The display device 1 includes a light adjuster 10, a display panel 30, and a light source 60. A third direction Z is a direction in which the light adjuster 10, the display panel 30, and the light source 60 are stacked. A first direction X is one of two directions orthogonal to the third direction Z, and a second direction Y is the other direction. The first direction X and the second direction Y are orthogonal to each other. In the display device 1, the light source 60, the light adjuster 10, and the display panel 30 are stacked in the stated order from one side in the third direction Z toward the other side.

FIG. 2 is a schematic sectional view of components included in the display device 1. In FIGS. 1 and 2, a gap is provided between the light source 60 and the light adjuster 10 and between the light adjuster 10 and the display panel 30. The gap is provided to make the diagram easier to understand and is not essential in the actual display device 1, but in the embodiment, an air gap is provided between the light source 60 and the light adjuster 10 and between the light adjuster 10 and the display panel 30.

The light adjuster 10 has a configuration in which a first polarization layer 11, a first liquid crystal panel 20A, a second polarization layer 12, a first retardation plate 13, a second liquid crystal panel 20B, and a second retardation plate 14 are stacked from the one side in the third direction Z toward the other side. The first polarization layer 11 and the second polarization layer 12 as well as a third polarization layer 41 and a fourth polarization layer 42 to be described later are optical members each of which transmits polarized light most in a specific direction. The specific direction is referred to as a transmission axis direction. The transmission axis direction extends along the polarization layer. Thus, the transmission axis direction is orthogonal to the third direction Z. A direction orthogonal to the transmission axis direction and the third direction Z is referred to as an absorption axis direction. The absorption axis direction is a polarization direction in which light is most unlikely to pass through the polarization layer. The first retardation plate 13 and the second retardation plate 14 are optical members that change the phase of light entering from the one side in the third direction Z and transmit the light to the other side in the third direction Z.

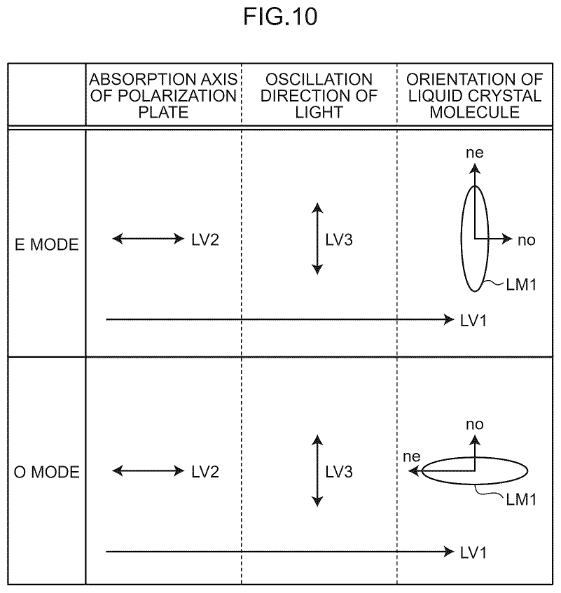

The first liquid crystal panel 20A and the second liquid crystal panel 20B are liquid crystal panels. Hereinafter, the term “liquid crystal panel” collectively means the first liquid crystal panel 20A and the second liquid crystal panel 20B. The first liquid crystal panel 20A is a liquid crystal panel of what is called a twisted nematic (TN) mode. In a TN-mode panel, the transmission axes (and absorption axes) of two polarization layers (the first polarization layer 11 and the second polarization layer 12) facing each other with a liquid crystal panel therebetween intersect each other. In the TN mode, when no voltage is applied, a plurality of liquid crystal molecules arranged in the third direction Z twist the polarization direction of light, thereby establishing a state (chirality) in which the light can pass through both transmission axes of the two polarization layers. In the TN mode, when voltage is applied, the chirality is lost and light no longer passes therethrough. The second liquid crystal panel 20B is a liquid crystal panel of what is called an electrically controlled birefringence (ECB) mode. In the ECB mode, the long-axis direction (ne in FIG. 10) of the liquid crystal molecules when no voltage is applied is parallel to a first substrate 21 and a second substrate 22 (horizontal orientation). When voltage is applied to a liquid crystal in such an ECB-mode liquid crystal panel, the liquid crystal molecules are raised up so that the long-axis direction of the liquid crystal molecules are aligned a direction along the third direction Z, thereby changing the transmission degree of light.

The liquid crystal panel has a configuration in which a first substrate 21 is provided on the one side of liquid crystal LM and a second substrate 22 is provided on the other side. The first substrate 21 and the second substrate 22 are light-transmitting substrates. The light-transmitting substrates are, for example, glass substrates but not limited thereto and may be substrates of any other light-transmitting material. Hereinafter, the term “one surface” means a surface of a plate-shaped component on the one side in the third direction Z. The term “the other surface” means a surface of the plate-shaped component on the other side in the third direction Z.

A first electrode FE1 is formed on the other surface of the first substrate 21. A second electrode FE2 is formed on the one surface of the second substrate 22. The first electrode FE1 and the second electrode FE2 are electrodes provided to cover a display region AA. The other surface of the first electrode FE1 and the other surface of the first substrate 21 in an area in which the first electrode FE1 is not formed, are covered by an insulating layer 23. The one surface of the second electrode FE2 and the one surface of the second substrate 22 in an area in which the second electrode FE2 is not formed, are covered by an insulating layer 24. The display region AA will be described later.

The potential of at least one of the first electrode FE1 and the second electrode FE2 can be changed in accordance with ON/OFF of operation of the liquid crystal panel. In other words, voltage generated between the first electrode FE1 and the second electrode FE2 is different between a case where the liquid crystal panel is in operation (ON) and a case where the liquid crystal panel is not in operation (OFF).

At least in the display region AA, the liquid crystal LM is interposed between the insulating layer 23 and the insulating layer 24. Outside the display region AA, a seal 25 is interposed between the insulating layer 23 and the insulating layer 24. Although not illustrated, the seal 25 is a frame-shaped member surrounding the liquid crystal LM when viewed at a viewpoint of viewing a plane (X-Y plane) orthogonal to the third direction Z from the front. The liquid crystal IM is surrounded by the seal 25 between the insulating layer 23 and the insulating layer 24, and accordingly, enclosed in the liquid crystal panel.

An alignment film 23a is provided on the other surface of the insulating layer 23 at least in an area where the display region AA is covered. An alignment film 24a is provided on the one surface of the insulating layer 24 at least in an area where the display region AA is covered. With the alignment films 23a and 24a, the liquid crystal molecules contained in the liquid crystal LM are aligned in a specific direction. The orientation of each liquid crystal molecule changes as the potential difference between the first electrode FE1 and the second electrode FE2 changes.

The display panel 30 is a liquid crystal panel different from the first liquid crystal panel 20A and the second liquid crystal panel 20B. The display panel 30 includes a plurality of pixels. The display panel 30 is an image-display liquid crystal panel provided to be able to individually control the transmission degree of light at the position of each pixel in accordance with input image data from the outside.

The display panel 30 illustrated in FIG. 2 is an in-plane switching (IPS) liquid crystal panel. In the display panel 30, a pixel substrate 31 is provided on the one side in the third direction Z with respect to liquid crystal LQ, and a counter substrate 32 is provided on the other side. The third polarization layer 41 is provided on the one surface side of the pixel substrate 31. The fourth polarization layer 42 is provided on the other surface side of the counter substrate 32. Hereinafter, the term “panel unit DP” means part of the configuration of the display panel 30 other than the third polarization layer 41 and the fourth polarization layer 42.

For example, a common electrode CE, an insulating layer 33, pixel electrodes P, and an insulating layer 34 are stacked on the other surface of the pixel substrate 31 from the one side in the third direction Z toward the other side. For example, a color filter 35 is stacked on the one surface of the counter substrate 32. A seal 36 is interposed between the insulating layer 34 and the color filter 35 outside the display region AA. The seal 36 has the same shape as the seal 25 described above. The liquid crystal LQ is surrounded by the seal 36 between the insulating layer 34 and the color filter 35, and accordingly, enclosed in the display panel 30.

The display region AA is a region in which a plurality of pixel electrodes P are disposed in the display panel 30. The pixel electrodes P are two-dimensionally arranged along an X-Y plane in the display region AA. The display panel 30 is an active matrix display panel that can display and output any desired image by individually controlling the transmission degree of light at each pixel electrode P. More specifically, in the display panel 30 of the embodiment, a potential as a reference is provided to the common electrode CE. Individual potentials (pixel signals) are provided to the pixel electrodes P, and accordingly, the transmission degree of light at each pixel electrode P are individually controlled. Thus, the display region AA is a region in which an image is displayed and output.

The light source 60 emits light toward the other surface side where a polarization generation layer 53 is provided. The polarization generation layer 53 is an optical member that converts light emitted from the other surface of the light source 60 into polarized light at a specific angle. The polarization generation layer 53 is, for example, a dual brightness enhancement film (DBEF) but not limited thereto and only needs to be a component that can convert light emitted from the other surface of the light source 60 into polarized light at a specific angle. Light emitted by the light source 60 passes through the polarization generation layer 53, the light adjuster 10, the third polarization layer 41, the display panel 30, and the fourth polarization layer 42 and exits from the other surface side of the display device 1.

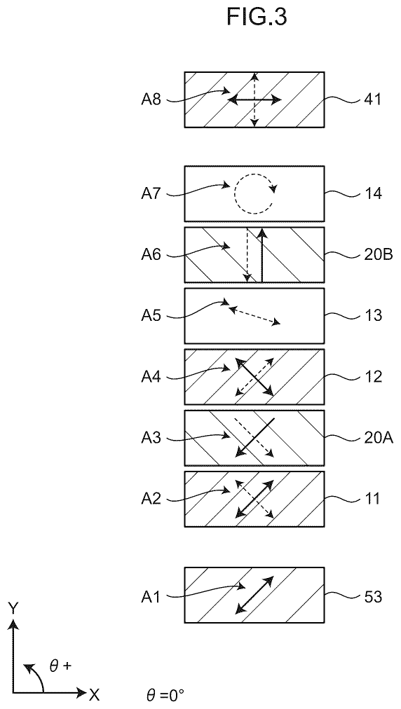

The following describes changes in the polarization direction of light from when light is emitted by the light source 60 to when the light exits from the other surface side of the display device 1, with reference to FIG. 3.

FIG. 3 is a diagram illustrating optical effects provided to light emitted by the light source 60 until the light reaches the display panel 30. In the following description, polarized light in the first direction X is defined as polarized light at 0°. In description with reference to FIG. 3, the angle of polarization is expressed with respect to the polarized light at 0°. Also in description with reference to FIG. 3, of the changes in the polarization direction of light, a change with anticlockwise rotation by r° along an X-Y plane is referred to as a “change of +r°”. A change with opposite (clockwise) rotation by r° is referred to as a “change of −r°”. The variable r is a real number equal to or larger than zero.

In the embodiment, the transmission axis of the polarization generation layer 53 is set so that light emitted from the other surface of the light source 60 is converted into polarized light at 45° and transmitted. Thus, polarized light having passed through the polarization generation layer 53 and incident on the first polarization layer 11 is polarized light at 45°. In FIG. 3, this transmission axis is illustrated as an optical property A1.

The transmission and absorption axes of the first polarization layer 11 are set to allow maximum transmission of polarized light at 45°. Among arrows illustrated as an optical property A2 in FIG. 3, the solid-line arrow represents the transmission axis at 45°, and the dashed-line arrow represents the absorption axis at 135°.

The first liquid crystal panel 20A is provided between the first polarization layer 11 and the second polarization layer 12 to affect the polarization direction of light. Specifically, the first liquid crystal panel 20A controls the degree (twist angle) of change in the polarization direction of light passing therethrough in the third direction Z by controlling the orientation of each liquid crystal molecule contained in the liquid crystal LM.

In the embodiment, a refractive index difference (Δn) caused by the liquid crystal molecules and the thickness (d) of the liquid crystal LM are set so that the first liquid crystal panel 20A can provide the maximum twist angle of approximately 100° to light. For example, the first liquid crystal panel 20A can convert incident polarized light at 323° into polarized light at 223° and emit the polarized light. More specifically, the first liquid crystal panel 20A is designed such that, for example, the refractive index difference (Δn) is 0.2 and a cell gap by which the thickness (d) of the liquid crystal LM is defined is 3 μm to 10 μm (for example, 8 μm). The twist angle provided to light by the first liquid crystal panel 20A is not limited to the maximum angle but is adjusted as appropriate in a range smaller than the maximum angle in accordance with voltage applied to the liquid crystal. Thus, the first liquid crystal panel 20A controls the twist angle that is provided to light incident therein through the first polarization layer 11, thereby controlling the degree of the transmission of the light through the first liquid crystal panel 20A to the second polarization layer 12.

Among arrows illustrated as an optical property A3 in FIG. 3, the solid-line straight arrow corresponds to the polarization direction of light having entered from the first polarization layer 11, the dashed-line arrow corresponds to the polarization direction of light allowed to pass through the second polarization layer 12.

The transmission and absorption axes of the second polarization layer 12 are set to allow maximum transmission of polarized light at 135°. Among arrows illustrated as an optical property A4 in FIG. 3, the solid-line arrow represents the transmission axis at 135°, and the dashed-line arrow represents the absorption axis at 45°. The angle difference between the transmission axis of the first polarization layer 11 and the transmission axis of the second polarization layer 12 is 90°. Thus, in operation, the first liquid crystal panel 20A can generate a twist angle that allows light from the first polarization layer 11 to pass through the first liquid crystal panel 20A to the second polarization layer 12.

The first retardation plate 13 is a retardation plate having a slow axis at 157.5° and a retardation of 270 nm. Polarized light at 135° having passed through the second polarization layer 12 and having entered the first retardation plate 13 is converted into polarized light at 90° and exits to the second liquid crystal panel 20B. The dashed-line arrow indicated as an optical property A5 in FIG. 3 represents the slow axis at 157.5°.

The second liquid crystal panel 20B is provided between the first retardation plate 13 and the second retardation plate 14 to affect the polarization direction of light. Specifically, the second liquid crystal panel 20B controls the degree (twist angle) of change in the polarization direction of light passing through in the third direction Z by controlling the orientation of each liquid crystal molecule contained in the liquid crystal LM.

In the embodiment, the second liquid crystal panel 20B does not affect the polarization direction of light in effect. In other words, the second liquid crystal panel 20B provides the twist angle of 0° to light. Specifically, the second liquid crystal panel 20B of the embodiment is designed such that, for example, the refractive index difference (Δn) is 0.2 and the cell gap by which the thickness (d) of the liquid crystal LM is defined is 2 μm to 5 μm (for example, 3 μm). More specifically, the second liquid crystal panel 20B illustrated in FIG. 3 is provided such that the transmission axis is 0° and the absorption axis is 90°.

Among arrows illustrated as an optical property A6 in FIG. 3, the solid-line straight arrow corresponds to the rubbing direction on one of the first substrate 21 side and the second substrate 22 side of the second liquid crystal panel 20B, and the dashed-line arrow corresponds to the rubbing direction on the other of the first substrate 21 side and the second substrate 22 side of the second liquid crystal panel 20B. These rubbing directions optically act as slow axes.

The second retardation plate 14 is a negative-C retardation plate with a retardation defined in the range of −50 nm to −300 nm. Polarized light at 90° having entered the second retardation plate 14 is converted into polarized light at 0° and exits to the third polarization layer 41. Change in the polarization direction of light due to the negative-C retardation plate is indicated as an optical property A7 in FIG. 3.

The transmission axis of the third polarization layer 41 is set to allow maximum transmission of polarized light at 0°. Thus, light having passed through the second retardation plate 14 can pass through the third polarization layer 41. Polarized light having passed through the third polarization layer 41 and incident on the panel unit DP is polarized light at 0°. In FIG. 3, this transmission axis is illustrated as an optical property A8.

Although specific configurations of the panel unit DP and the fourth polarization layer 42, illustration of which is omitted in FIG. 3, can be freely designed, the panel unit DP is provided to, for example, apply a change of +90° to polarized light passing therethrough from the one side in the third direction Z to the other side. In other words, polarized light undergoes the change of +90° while passing through the panel unit DP. Thus, polarized light having passed through the panel unit DP and incident on the fourth polarization layer 42 is polarized light at 90°. FIG. 3 illustrates an angle V10b of polarized light incident on the panel unit DP and an angle V10a of polarized light having transmitted through the panel unit DP. In this example, a transmission axis direction V11 of the fourth polarization layer 42 is set to allow maximum transmission of polarized light at 90°. Thus, light having passed through the panel unit DP can transmit through the fourth polarization layer 42.

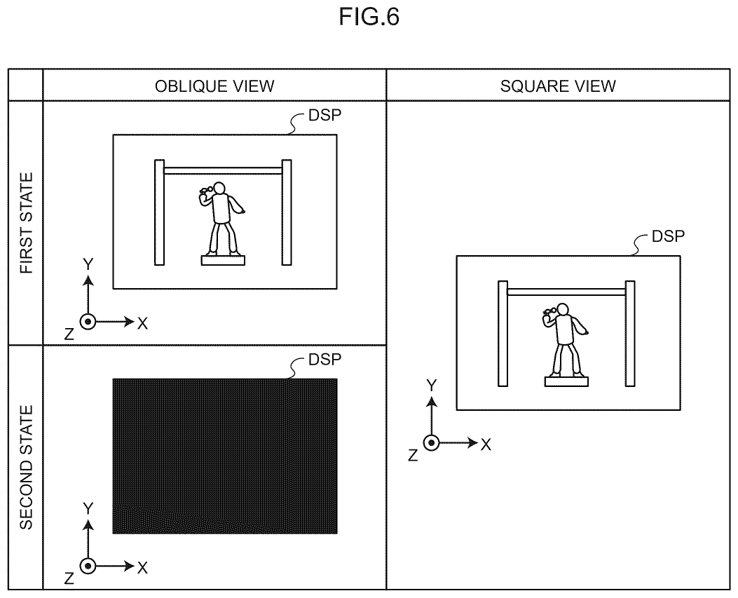

The following describes optical effects induced by the liquid crystal panel. When the liquid crystal panel is not in operation (OFF), the transmission degree of light on one side in the first direction X is hardly different from that on the other side in the first direction X. Specifically, when the first liquid crystal panel 20A and the second liquid crystal panel 20B are both not in operation (OFF) and an image DSP (refer to FIG. 6) on the display device 1 is viewed from each of two viewpoints that are line symmetric in the first direction X with respect to a viewpoint of viewing the display device 1 from the front, the brightnesses of the image recognized at the two viewpoints are substantially equal to each other. Hereinafter, the term “image DSP” means an image displayed and output by the display panel 30 of the display device 1. In this case, at a viewpoint of viewing the display device 1 from the front, the image can be viewed with a brightness equal to or higher than brightnesses at other viewpoints. In other words, when the liquid crystal panel is not in operation (OFF), the transmission degree of light along the third direction Z through the liquid crystal panel is equal to or larger than the transmission degree of light intersecting the third direction Z through the liquid crystal panel.

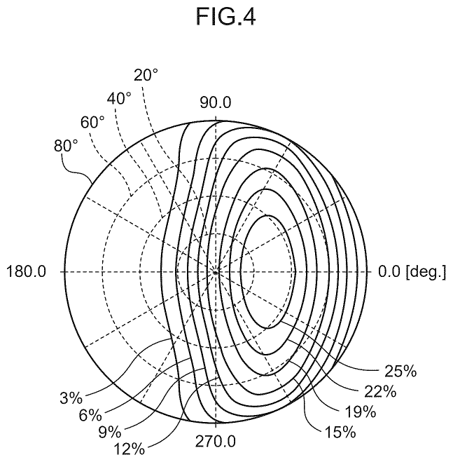

When the liquid crystal panel is in operation (ON), the transmission degree of light on the one side in the first direction X is different from that on the other side in the first direction X. The following describes a viewing angle characteristic of the display device 1 that is obtained in accordance with the transmission degree of light when the liquid crystal panel is in operation (ON), with reference to FIG. 4.

FIG. 4 is a diagram illustrating an exemplary viewing angle characteristic of the display device 1 that is obtained in accordance with the transmission degree of light when the first liquid crystal panel 20A is in operation (ON). The center of concentric circles in FIG. 4 corresponds to the normal of the display device 1 in the third direction Z, and the concentric circles centered at the normal indicate tilt angles of 20°, 40°, 60°, and 80°, respectively, with respect to the normal. This illustrated characteristic diagram is obtained by connecting regions of transmittances in respective directions that are equal to each other.

As illustrated in FIG. 4, relatively high transmittance of light is obtained when user's line of sight toward the display device 1 is tilted toward one side (0°) in the first direction X. Relatively high transmittance of light is also obtained when user's line of sight toward the display device 1 is aligned with the normal direction, in other words, when the user views the display device 1 from the front. However, when user's line of sight toward the display device 1 is tilted toward the other side (180°) in the first direction X, the transmittance of light significantly decreases as compared to the case of tilt toward the one side. In particular, when the tilt angle of the line of sight toward the other side (180°) in the first direction X exceeds 30°, the transmittance is 3% or lower in the example illustrated in FIG. 4 and the brightness is so low that the image substantially cannot be viewed by a human.

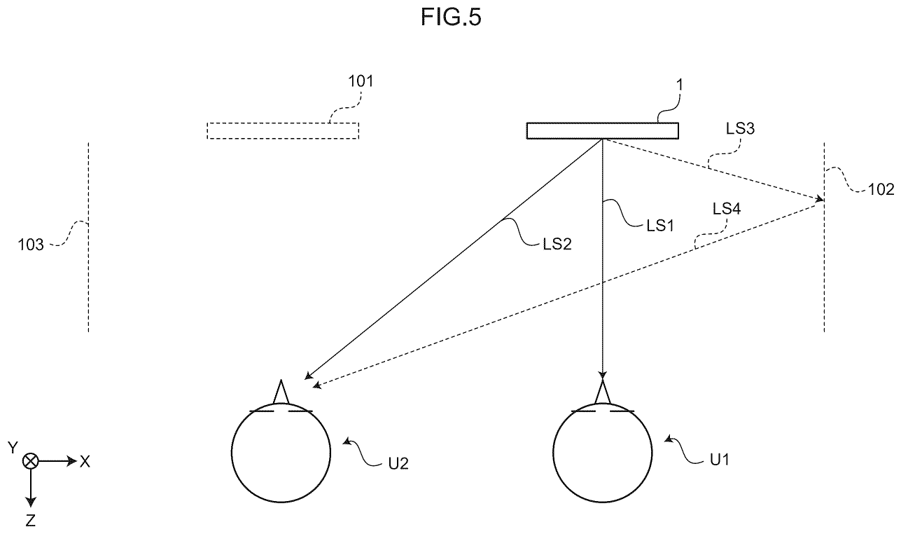

The viewing angle characteristic described above with reference to FIG. 4 can be utilized for display output control intended to allow a user viewing the display device 1 from the front or viewing the display device 1 from the one side in the first direction X to view the image but not to allow a user viewing the display device 1 from the other side in the first direction X to view the image. An example in which such a display output control is applied will be described below with reference to FIG. 5.

FIG. 5 is a schematic diagram illustrating an example of the relation between the display device 1, a user U1 who can view the image DSP regardless of whether the liquid crystal panel is in operation or non-operation (ON or OFF), and a user U2 who cannot view the image DSP when the liquid crystal panel is in operation (ON).

As illustrated in FIG. 5, the display device 1 and the user U1 face each other in the third direction Z. Although not illustrated in FIG. 5, the other surface side of the display device 1, in other words, the fourth polarization layer 42 side is the user U1 side in FIG. 5. Thus, in display output by the display device 1, light LS1 of the image toward the user U1 is along the third direction Z. In such a positional relation between the display device 1 and the user U1, it can be said that the user U1 is located at a viewpoint of viewing the display device 1 from the front. The user U2 is located at a position of obliquely viewing the other surface side of the display device 1 in a direction tilted toward the other side in the first direction X relative to the third direction Z. In other words, in display output by the display device 1, light LS2 of the image toward the user U2 is tilted toward the other side (180° in FIG. 4) in the first direction X. In such a positional relation between the display device 1 and the user U2, it can be said that the user U2 is located at a viewpoint of obliquely viewing the display device 1.

A case where the positional relation between the display device 1 and the users U1 and U2 as illustrated in FIG. 5 is established is, for example, a case where the display device 1 is provided in a four-wheel automobile in which the user U2 is seated on the driver's seat and the user U1 is seated on the front passenger's seat, but is not limited thereto. The positional relation can be established, for example, when the display device 1 is provided as a personal monitor for each passenger on an aircraft such as a passenger airplane, and any other case may be included.

FIG. 6 is a schematic view illustrating a difference between the image DSP viewed by a user viewing the display device 1 from the front and the image DSP viewed by a user obliquely viewing the display device 1. The user viewing the display device 1 from the front is, for example, the user U1 in FIG. 5. The user obliquely views the display device 1 is, for example, the user U2 in FIG. 5. In description with reference to FIG. 6, a state of the display device 1 in which the display panel 30 performs the image display and the liquid crystal panel is not in operation (OFF) is referred to as a first state. A state of the display device 1 in which the display panel 30 performs the image display and the liquid crystal panel is in operation (ON) is referred to as a second state.

As described above, a degree at which light along the third direction Z passes through the liquid crystal panel when the liquid crystal panel is not in operation (OFF) is equal to or larger than a degree at which light intersecting the third direction Z passes through the liquid crystal panel. As described above with reference to FIG. 4, when a user views the display device 1 from the front, relatively high transmittance of light is obtained even while the liquid crystal panel is in operation (ON). Thus, a user viewing the display device 1 from the front can view the image DSP illustrated in FIG. 6 irrespective of whether the operation state of the display device 1 is in the first state or in the second state. The aspect of the image DSP illustrated in FIG. 6 is merely exemplary and the present disclosure is not limited thereto. The display panel 30 may display and output any desired image.

As described above with reference to FIG. 4, when a user's line of sight toward the display device 1 is tilted toward the other side (180°) in the first direction X while the liquid crystal panel is in operation (ON), transmittance of light significantly decreases as compared to the case of tilt toward the one side. Thus, a user obliquely viewing the display device 1 from the other side in the first direction X substantially cannot view the image DSP when the operation state of the display device 1 is in the second state. However, when the operation state of the display device 1 is in the first state, such significant decrease in the transmittance of light as described above with reference to FIG. 4 does not occur for the other side (180°) in the first direction X. Thus, when the operation state of the display device 1 is in the first state, a user obliquely viewing the display device 1 from the other side in the first direction X can view substantially the same image DSP as that for a user viewing the display device 1 from the front.

As illustrated in FIG. 6, the image DSP is viewed as a rectangular image. Accordingly, in the embodiment, the display region AA has a rectangular shape corresponding to the image DSP illustrated in FIG. 6 when the display device 1 is viewed from the front. Two sides among the four sides of the rectangle extend along the first direction X, and the other two sides extend along the second direction Y. The light adjuster 10 of the embodiment causes the transmission degree of light tilted toward one side in the longitudinal direction of the rectangle (the first direction X) with respect to the third direction Z and the transmission degree of light along a line tilted toward the other side in the longitudinal direction to be different from each other. Accordingly, the light adjuster 10 generates a difference in viewing between the first and second states described above with reference to FIG. 6.

The basic concept of visual recognition control of the image DSP for each of the users U1 and U2 assumed in the first and second states have been described above, but even in the second state, a light route may be established in which the user U2 can view the image DSP. For example, assume that there is an object such as a reflection body 102 illustrated in FIG. 5, which reflects light LS3 from the display device 1, thereby generating light LS4. In this case, a situation sometimes unintentionally occurs in which the image DSP output from the display device 1 in the second state can be viewed from the user U2 as well when the light LS4 reaches the user U2. For example, when FIG. 5 is an example of the inside of a four-wheel automobile, a situation potentially occurs when a side window glass on the front passenger seat side functions as the reflection body 102.

Thus, the embodiment employs a mechanism that reduces generation of light emitted from the display device 1 and traveling in an oblique direction, such as the light LS4, which is on the one side (0°) in the first direction X and unnecessary for visual recognition of the image DSP by the user U1. Specifically, generation of such emitted light is reduced by including the second liquid crystal panel 20B, which is an ECB-mode liquid crystal panel, in the configuration of the light adjuster 10.

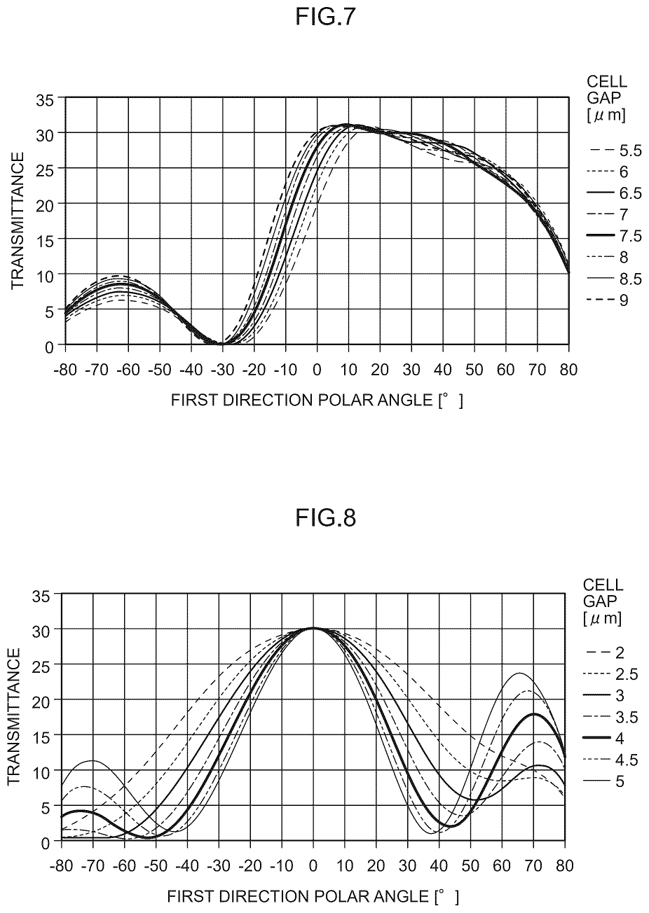

FIG. 7 is a multiple line graph illustrating the relation between a first direction polar angle and the light transmittance of the first liquid crystal panel 20A in operation. In the horizontal axis direction in FIGS. 7, 8, and 9, the line of sight at an angle tilted toward the one side in the first direction X is defined as a viewing angle of a positive (+) value with respect to a reference (viewing angle of 0°) at the line of sight of viewing the display device 1 from the front, and the line of sight at an angle tilted toward the other side in the first direction X is defined as a viewing angle of a negative (−) value. The vertical axial direction in FIGS. 7 and 8 represents the light transmittance in percent (%). The light transmittance here is synonymous with the brightness of emitted light relative to the brightness of incident light.

The numerical values given to the respective line plots in FIG. 7 indicate the cell gap (unit: μm) of the first liquid crystal panel 20A. In other words, each of the line plots indicates light transmittance of the first liquid crystal panel 20A with a cell gap corresponding to the numerical value given to the line plot. Voltage applied to the liquid crystal LM is the same (for example, 2.5 V) in each of the first liquid crystal panels 20A with different cell gaps.

As illustrated in FIG. 7, by operating the first liquid crystal panel 20A, light transmittance to the minus (−) side is significantly lower than that to the plus side (+). In other words, by operating the first liquid crystal panel 20A, the light transmittance to the other side in the first direction X is significantly lower than that to the one side in the first direction X. This indicates that when the display output image of the display device 1 is viewed from the other side in the first direction X, the image is seen in a significantly darker state than when the display output image of the display device 1 is viewed from the one side in the first direction X, thereby making it difficult to recognize the image. In particular, the light transmittance is substantially zero at the first direction polar angle of −30°, making it practically impossible to view the display output image of the display device 1 at the polar angle.

As indicated on the plus side (+) of the graph of FIG. 7, the light transmittance to the one side in the first direction X is approximately 10% even at the horizontal polar angle of 80° although the light transmittance tends to decrease as the degree of deviation from 0° increases. Such light transmittance on the plus (+) side may cause light emitted from the display device 1 and traveling in an oblique direction, such as the light LS4 described above, which is on the one side (0°) in the first direction X and unnecessary for visual recognition of the image DSP by the user U1. In other words, when the light adjuster 10 is composed only of a TN-mode liquid crystal panel such as the first liquid crystal panel 20A, such emitted light in an oblique direction cannot be sufficiently reduced.

FIG. 8 is a multiple line graph illustrating the relation between the first direction polar angle and the light transmittance of the second liquid crystal panel 20B in operation. The numerical values given to the respective line plots in FIG. 8 each indicate the cell gap (unit: μm) of the second liquid crystal panel 20B. In other words, each of the line plots indicates light transmittance of the second liquid crystal panel 20B with a cell gap corresponding to the numerical value given to the line plot. Voltage applied to the liquid crystal LM is the same (for example, 2.9 V) in each of the second liquid crystal panels 20B with different cell gaps.

As illustrated in FIG. 8, by operating the second liquid crystal panel 20B, the light transmittance on the plus (+) side can be reduced significantly as compared to the first liquid crystal panel 20A. In particular, the second liquid crystal panel 20B with a cell gap of 3 μm or smaller can more reliably significantly reduce the light transmittance on the plus (+) side as compared to the first liquid crystal panel 20A. As illustrated in FIGS. 7 and 8, the first liquid crystal panel 20A and the second liquid crystal panel 20B have characteristics with more abrupt change as their cell gaps increase, and the degree of transmittance change (jump) in accordance with change in the first direction polar angle tends to be larger.

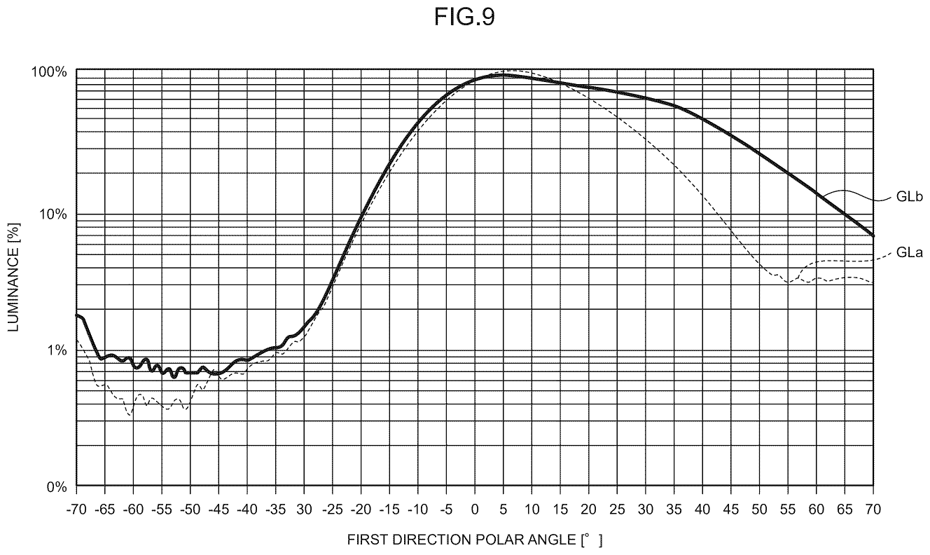

FIG. 9 is a multiple line graph illustrating a brightness difference between the display device 1 of the embodiment and a comparative example in which only a TN-mode liquid crystal panel is provided in the light adjuster 10. In FIG. 9, brightness is represented as luminance (%) normalized with respect to the normal direction of the vertical axial direction. In expression using the normalized luminance (%), the normal luminance of the panel plate surface of a liquid crystal panel TN, in other words, the luminance at the viewing angle of 0° is regarded as 100% luminance, and the luminance at a viewing angle corresponding to the angle relative to the normal direction at 0° is expressed as percentage. For example, when the normal luminance is 1000 nit and the luminance at the viewing angle of +30° is 100 nit, the viewing angle of +30° is represented as 10%. In the comparative example in which only a TN-mode liquid crystal panel is provided in the light adjuster 10, as illustrated with a line plot GLb, the brightness gradually decreases with the deviation from 0° on the plus (+) side, in other words, the one side in the first direction X. Thus, it is impossible to sufficiently reduce light emitted from the display device 1 and traveling in an oblique direction, such as the light LS4 described above, which is on the one side (0°) in the first direction X and unnecessary for visual recognition of the image DSP by the user U1.

However, in the embodiment in which both the first liquid crystal panel 20A and the second liquid crystal panel 20B are included in the light adjuster 10, as illustrated with a line plot GLa, the brightness decreases significantly with the deviation from 0° as compared to the comparative example. In particular, at the first direction polar angle of 55° or larger, the brightness can be reduced to a level where the display output image of the display device 1 cannot be substantially visually recognized. Thus, according to the embodiment, it is possible to reduce light emitted from the display device 1 and traveling in an oblique direction, such as the light LS4 described above, which is on the one side (0°) in the first direction X and unnecessary for visual recognition of the image DSP by the user U1. When it is desired to reduce reflected light such as the light LS4 to approximately 18, the relation between the reflectance of a component such as the reflection body 102 and the brightness illustrated in FIG. 9 needs to be considered. For example, assuming that the reflectance of the reflection body 102 is 8%, when the brightness is equal to or smaller than 12%, reflected light such as the light LS4 can be reduced to 1% or lower. In the example illustrated in FIG. 9, the brightness drops to 12% or lower around angles exceeding 43°, which is sufficient for reducing reflected light such as the light LS4.

Either an E mode or an O mode is employed in a liquid crystal panel for light adjustment, such as the first liquid crystal panel 20A and the second liquid crystal panel 20B.

FIG. 10 is a schematic view illustrating the difference between the E mode and the O mode. In FIG. 10, each liquid crystal molecule contained in the liquid crystal LM is illustrated as a liquid crystal molecule LM1. The liquid crystal molecule LM1 exhibits uniaxial optical anisotropic. Specifically, in one direction, an axis “ne” with a higher refractive index (n) than the others is generated. In addition, an axis orthogonal to the axis “ne” is referred to as an axis “no”. The letter “e” of the axis “ne” is derived from the initial letter of “extraordinary”. The letter “o” of the axis “no” is derived from the initial letter of “ordinary”. The letter “n” of the axes “ne” and “no” is derived from the unit of the refractive index (n).

In the E mode, the orientation of the liquid crystal molecule LM1 is set so that the oscillation direction LV3 of linearly polarized light after passing through the polarization layer that allows light LV1 entering the liquid crystal panel to pass therethrough is parallel to the direction of the axis “ne” of the liquid crystal molecule LM1. Thus, in the E mode, the liquid crystal molecule LM1 is arranged so that the axis “ne” is orthogonal to the absorption axis LV2 of the polarization layer.

In the O mode, the orientation of the liquid crystal molecule LM1 is set so that the oscillation direction LV3 of linearly polarized light after passing through the polarization layer that allows light LV1 entering the liquid crystal panel to pass therethrough is orthogonal to the direction of the axis “ne” of the liquid crystal molecule LM1. Thus, in the O mode, the liquid crystal molecule LM1 is arranged so that the axis “ne” is parallel to the absorption axis LV2 of the polarization layer.

The first liquid crystal panel 20A of the embodiment is, for example, an E-mode liquid crystal panel. The second liquid crystal panel 20B of the embodiment is, for example, an O-mode liquid crystal panel.

### Modifications

The following describes modifications of the embodiment. For example, the first liquid crystal panel 20A may be an O-mode liquid crystal panel. Accordingly, both the first liquid crystal panel 20A and the second liquid crystal panel 20B may be an O-mode liquid crystal panel.

Alternatively, the second liquid crystal panel 20B may be an E-mode liquid crystal panel. Accordingly, both the first liquid crystal panel 20A and the second liquid crystal panel 20B may be an E-mode liquid crystal panel.

Although the first liquid crystal panel 20A is disposed closer to the light source 60 relative to the second liquid crystal panel 20B in the embodiment, the second liquid crystal panel 20B may be disposed closer to the light source 60 relative to the first liquid crystal panel 20A.

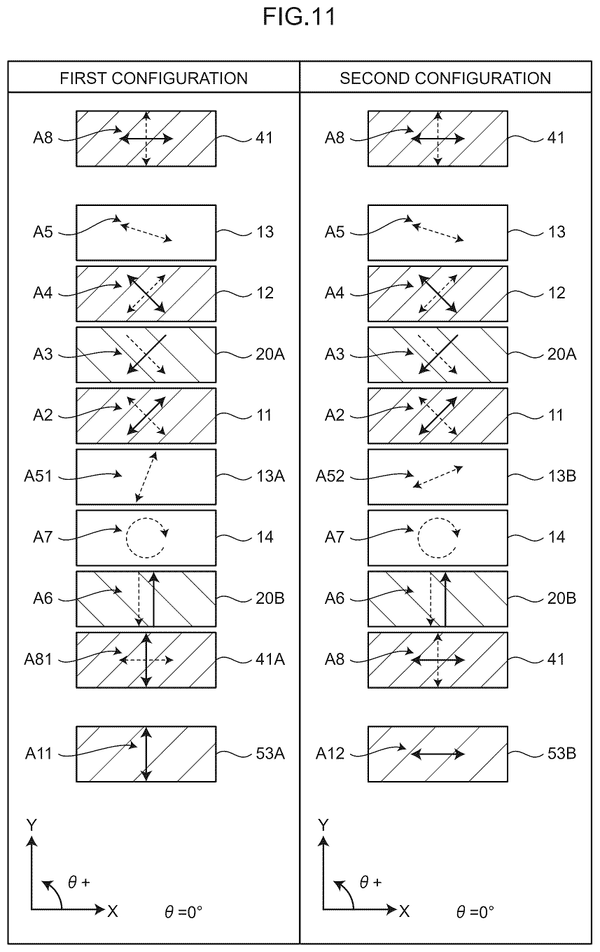

FIG. 11 is a diagram illustrating optical effects when the second liquid crystal panel 20B is disposed closer to the light source 60 relative to the first liquid crystal panel 20A, and the stacking order of components that cause such effects. Either of a first configuration and a second configuration illustrated in FIG. 11 may be employed as the configuration when the second liquid crystal panel 20B is disposed closer to the light source 60 relative to the first liquid crystal panel 20A. In description with reference to FIG. 11, any component identical to a component described above with reference to FIG. 3 is denoted by the same reference sign, and any different component is denoted by a different reference sign.

In the first configuration, the polarization generation layer 53 in the embodiment described above with reference to FIG. 3 is replaced with a polarization generation layer 53A. The polarization generation layer 53A has the same configuration as the polarization generation layer 53 except that the transmission axis thereof is set so that light emitted from the other surface of the light source 60 is converted into polarized light at 90° and transmitted. In FIG. 11, this transmission axis is illustrated as an optical property A11. In the first configuration, the configuration between the polarization generation layer 53 and the third polarization layer 41 in FIG. 3, in other words, the configuration corresponding to the light adjuster 10 in the embodiment is replaced with a configuration in which a polarization layer 41A, the second liquid crystal panel 20B, the second retardation plate 14, a retardation plate 13A, the first polarization layer 11, the first liquid crystal panel 20A, the second polarization layer 12, and the first retardation plate 13 are stacked in the stated order from the one side in the third direction Z toward the other side. Similarly to the gap between the polarization generation layer 53 and the first polarization layer 11 illustrated in FIGS. 2 and 3, an air gap is provided as the gap between the polarization generation layer 53A and the polarization layer 41A. The polarization layer 41A has the same configuration as the third polarization layer 41 except that the transmission axis thereof is set to allow maximum transmission of polarized light at 90°. In FIG. 11, this transmission axis is illustrated as an optical property A81. The retardation plate 13A is a retardation plate having a slow axis at 67.5° and a retardation of 270 nm. The dashed-line arrow indicated as an optical property A51 in FIG. 11 represents the slow axis at 67.5°. Except for matters otherwise stated above, the first configuration is the same as the configuration described above with reference to FIG. 3.

In the second configuration, the polarization generation layer 53 in the embodiment described above with reference to FIG. 3 is replaced with a polarization generation layer 53B. The polarization generation layer 53B has the configuration same as the polarization generation layer 53 except that the transmission axis thereof is set so that light emitted from the other surface of the light source 60 is converted into polarized light at 0° and transmitted. In FIG. 11, this transmission axis is illustrated as an optical property A12. In the second configuration, the configuration between the polarization generation layer 53 and the third polarization layer 41 in FIG. 3, in other words, the configuration corresponding to the light adjuster 10 in the embodiment is replaced with a configuration in which the third polarization layer 41, the second liquid crystal panel 20B, the second retardation plate 14, a retardation plate 13B, the first polarization layer 11, the first liquid crystal panel 20A, the second polarization layer 12, and the first retardation plate 13 are stacked in the stated order from the one side in the third direction Z toward the other side. Similarly to the gap between the polarization generation layer 53 and the first polarization layer 11 illustrated in FIGS. 2 and 3, an air gap is provided as the gap between the polarization generation layer 53B and the third polarization layer 41 facing the polarization generation layer 53B in the third direction Z. The retardation plate 13B is a retardation plate having a slow axis at 22.5° and a retardation of 270 nm. The dashed-line arrow indicated as the optical property A51 in FIG. 11 represents the slow axis at 22.5°. Except for matters otherwise stated above, the second configuration is the same as the configuration described above with reference to FIG. 3.

In the first configuration and the second configuration, the second polarization layer 12 provided between the first liquid crystal panel 20A and the first retardation plate 13 so that emitted light traveling in an oblique direction can be more reliably reduced. However, in the first configuration and the second configuration, the second polarization layer 12 positioned between the first liquid crystal panel 20A and the first retardation plate 13 may be eliminated. Without the second polarization layer 12, the overall light transmittance can be increased to perform brighter display output.

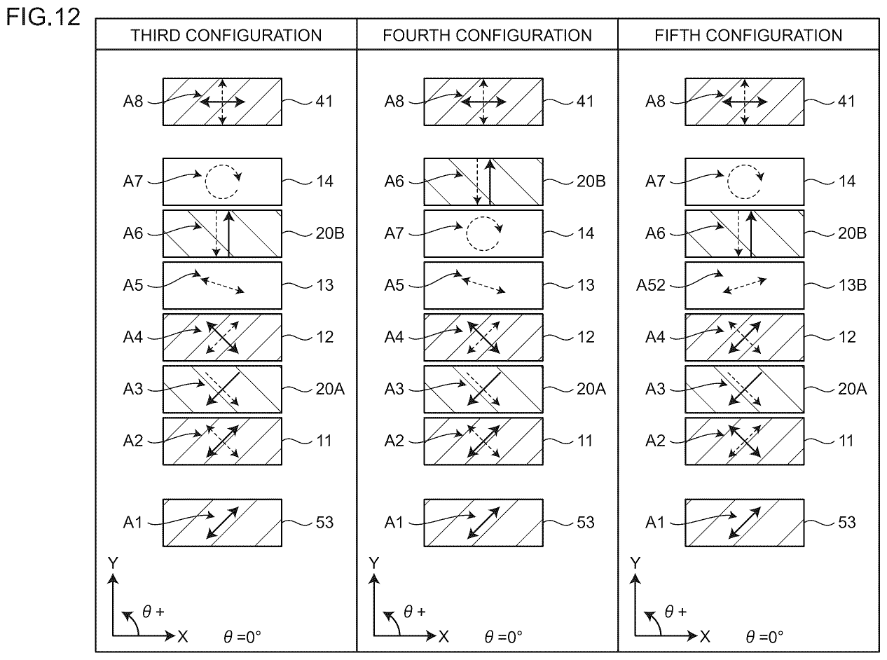

FIG. 12 is a diagram illustrating optical effects of the light adjuster due to stacking structures different from the configurations described above with reference to FIGS. 3 and 11, and the stacking order of components that cause such effects. In description with reference to FIG. 12, any component identical to components described above with reference to FIGS. 3 and 11 is denoted by the same reference sign, and any different component is denoted by a different reference sign.

A third configuration in FIG. 12 corresponds to a case where the E-mode second liquid crystal panel 20B is employed. In the third configuration, the configuration between the polarization generation layer 53 and the third polarization layer 41 in FIG. 3, in other words, the configuration corresponding to the light adjuster 10 in the embodiment is replaced with a configuration in which the first polarization layer 11, the first liquid crystal panel 20A, the second polarization layer 12, the first retardation plate 13, the second liquid crystal panel 20B, and the second retardation plate 14 are stacked in the stated order from the one side in the third direction Z toward the other side. Among these components, the second liquid crystal panel 20B is in E-mode. Except for matters otherwise stated above, the third configuration is the same as the configuration described above with reference to FIG. 3.

A fourth configuration in FIG. 12 corresponds to a case where the second liquid crystal panel 20B is disposed closer to the display panel 30 relative to the second retardation plate 14. In the fourth configuration, the configuration between the polarization generation layer 53 and the third polarization layer 41 in FIG. 3, in other words, the configuration corresponding to the light adjuster 10 in the embodiment is replaced with a configuration in which the first polarization layer 11, the first liquid crystal panel 20A, the second polarization layer 12, the first retardation plate 13, the second retardation plate 14, and the second liquid crystal panel 20B are stacked in the stated order from the one side in the third direction Z toward the other side. Except for matters otherwise stated above, the fourth configuration is the same as the configuration described above with reference to FIG. 3.

A fifth configuration in FIG. 12 corresponds to a case where the O-mode first liquid crystal panel 20A is employed. In the fifth configuration, the configuration between the polarization generation layer 53 and the third polarization layer 41 in FIG. 3, in other words, the configuration corresponding to the light adjuster 10 in the embodiment is replaced with a configuration in which the first polarization layer 11, the first liquid crystal panel 20A, the second polarization layer 12, the retardation plate 13B, the second liquid crystal panel 20B, and the second retardation plate 14 are stacked in the stated order from the one side in the third direction Z toward the other side. Among these components, the first liquid crystal panel 20A is in O-mode. Except for matters otherwise stated above, the fifth configuration is the same as the configuration described above with reference to FIG. 3.

Although the second retardation plate 14 is disposed closer to the display panel 30 relative to the second liquid crystal panel 20B in the embodiment, the second liquid crystal panel 20B may be disposed closer to the display panel 30 relative to the second retardation plate 14 as in the fourth configuration.

As described above, a display device (display device 1) includes: a liquid crystal display panel (display panel 30) including a display region configured to output an image; a light source (light source 60) configured to emit light to one surface side of the liquid crystal display panel; and a light adjuster (light adjuster 10) interposed between the liquid crystal display panel and the light source and configured to control the transmission degree of light between the liquid crystal display panel and the light source. The light adjuster includes a first liquid crystal panel (first liquid crystal panel 20A) and a second liquid crystal panel (second liquid crystal panel 20B) that are stacked in a direction in which the light source and the liquid crystal display panel face each other, the first liquid crystal panel is a TN-mode liquid crystal panel, and the second liquid crystal panel is an ECB-mode liquid crystal panel. With this configuration, it is possible to make the brightness significantly decrease with the degree of deviation from the front (0° in FIG. 9) of the display device 1. In particular, at the first direction polar angle of 55° or larger, the brightness can be reduced to a level where the display output image of the display device 1 cannot be substantially visually recognized. Thus, according to the embodiment, it is possible to reduce leakage of light such as light emitted from the display device 1 and traveling in an oblique direction, which is unnecessary for visual recognition of the image DSP by the user U1.

The light adjuster (light adjuster 10) may be configured such that a first polarization layer (first polarization layer 11), the first liquid crystal panel (first liquid crystal panel 20A), a second polarization layer (second polarization layer 12), a first retardation plate (first retardation plate 13), the second liquid crystal panel (second liquid crystal panel 20B), and a second retardation plate (second retardation plate 14) are arranged in the order as listed from the light source (light source 60) side toward the liquid crystal display panel (display panel 30) side. With this configuration, as described above, it is possible to reduce leakage of light such as light emitted from the display device 1 and traveling in an oblique direction, which is unnecessary for visual recognition of the image DSP by the user U1.

Moreover, the light adjuster (light adjuster 10) may be configured such that a first retardation plate (first retardation plate 13), the second liquid crystal panel (second liquid crystal panel 20B), a second retardation plate (second retardation plate 14), a first polarization layer (first polarization layer 11A), the first liquid crystal panel (first liquid crystal panel 20A), and a second polarization layer (second polarization layer 12A) are arranged in the order as listed from the light source (light source 60) side toward the liquid crystal display panel (display panel 30) side. With this configuration, it is possible to reduce leakage of light such as light emitted from the display device 1 and traveling in an oblique direction, which is unnecessary for visual recognition of the image DSP by the user U1.

Moreover, the light adjuster (light adjuster 10) may be configured such that a first polarization layer (first polarization layer 11), the first liquid crystal panel (first liquid crystal panel 20A), a second polarization layer (second polarization layer 12), a first retardation plate (first retardation plate 13), a second retardation plate (second retardation plate 14), and the second liquid crystal panel (second liquid crystal panel 20B) are arranged in the order as listed from the light source (light source 60) side toward the liquid crystal display panel (display panel 30) side. With this configuration, it is possible to reduce leakage of light such as light emitted from the display device 1 and traveling in an oblique direction, which is unnecessary for visual recognition of the image DSP by the user U1.

Moreover, the first liquid crystal panel (first liquid crystal panel 20A) may be in E-mode. With this configuration, as described above, it is possible to reduce leakage of light such as light emitted from the display device 1 and traveling in an oblique direction, which is unnecessary for visual recognition of the image DSP by the user U1.

Moreover, the first liquid crystal panel (first liquid crystal panel 20A) may be in O-mode. With this configuration, it is possible to reduce leakage of light such as light emitted from the display device 1 and traveling in an oblique direction, which is unnecessary for visual recognition of the image DSP by the user U1.

Moreover, the second liquid crystal panel (second liquid crystal panel 20B) may be in E-mode. With this configuration, it is possible to reduce leakage of light such as light emitted from the display device 1 and traveling in an oblique direction, which is unnecessary for visual recognition of the image DSP by the user U1.

It should be understood that the present disclosure provides any other effects achieved by aspects described above in the present embodiment, such as effects that are clear from the description of the present specification or effects that could be thought of by the skilled person in the art as appropriate.

What is claimed is:

1. A display device comprising:
a liquid crystal display panel including a display region configured to output an image;
a light source configured to emit light to one surface side of the liquid crystal display panel; and
a light adjuster interposed between the liquid crystal display panel and the light source and configured to control the transmission degree of light between the liquid crystal display panel and the light source, wherein
the light adjuster includes a first liquid crystal panel and a second liquid crystal panel that are stacked in a direction in which the light source and the liquid crystal display panel face each other,
the first liquid crystal panel is a TN-mode liquid crystal panel, and
the second liquid crystal panel is an ECB-mode liquid crystal panel.

2. The display device according to claim 1, wherein the light adjuster is configured such that a first polarization layer, the first liquid crystal panel, a second polarization layer, a first retardation plate, the second liquid crystal panel, and a second retardation plate are arranged in the order as listed from the light source side toward the liquid crystal display panel side.

3. The display device according to claim 1, wherein the light adjuster is configured such that a first retardation plate, the second liquid crystal panel, a second retardation plate, a first polarization layer, the first liquid crystal panel, and a second polarization layer are arranged in the order as listed from the light source side toward the liquid crystal display panel side.

4. The display device according to claim 1, wherein the light adjuster is configured such that a first polarization layer, the first liquid crystal panel, a second polarization layer, a first retardation plate, a second retardation plate, and the second liquid crystal panel are arranged in the order as listed from the light source side toward the liquid crystal display panel side.

5. The display device according to claim 1, wherein the first liquid crystal panel is in E-mode.

6. The display device according to claim 1, wherein the first liquid crystal panel is in O-mode.

7. The display device according to claim 1, wherein the second liquid crystal panel is in O-mode.

8. The display device according to claim 1, wherein the second liquid crystal panel is in E-mode.
